(19) United States
(12) Patent Application Publication
(10) Pub. No.: US 2026/0134516 A1
(43) Pub. Date: May 14, 2026

(54) REAL-TIME HIGH-FIDELITY IMAGE RESTORATION USING ITERATIVE LEARNING

(71) Applicant: GOOGLE LLC, Mountain View, CA (US)

(72) Inventors: Tingbo HOU, Santa Clara, CA (US); Yu-Chuan SU, Kirkland, WA (US); Yang ZHAO, Bothell, WA (US); Xuhui JIA, Bellevue, WA (US); Matthias GRUNDMANN, San Jose, CA (US)

(21) Appl. No.: 19/118,303

(22) PCT Filed: May 31, 2023
(86) PCT No.: PCT/US2023/023964

§ 371 Date: Apr. 3, 2025

Related U.S. Application Data
(60) Provisional application No. 63/413,282, filed on Oct. 5, 2022.

(51) Int. Cl. G06T 5/60; G06T 3/4046; G06T 7/70

(52) U.S. Cl. CPC G06T 5/60; G06T 3/4046; G06T 7/70; G06T 2207/10016; G06T 2207/20081; G06T 2207/20084; G06T 2207/30201

(57) ABSTRACT

Improved multi-stage methods for training models to enhance input images are provided. The multi-stage methods include training a first model to predict high-quality images based on synthetically degraded versions thereof. The first model is then used to generate, from the high quality images, enhanced, images that can then be used (in combination with synthetically degraded versions thereof) to train additional image enhancement models at two different resolutions. The additional image enhancement models are then applied, in series, to enhance input images. Such a serial image enhancement pipeline can then be used to train a smaller student model that can be implemented on smartphones or other limited-resource systems. This can include using the serial image enhancement pipeline to generate enhanced versions of low-quality images (e.g., as might be generated from a front-facing smartphone camera) that can then be used with the input low-quality images to train the student model.

### CROSS REFERENCE TO RELATED APPLICATION

This application claims priority to U.S. Provisional Application No. 63/413,282, filed Oct. 5, 2022, which is hereby incorporated by reference in its entirety.

### BACKGROUND

It is desirable in many applications to enhance the quality of images, e.g., to correct for image artifacts, low resolution, image noise, poor lighting, over-compression, motion blur, or other unwanted factors or features of an image. It is possible to train a neural network to automatically perform such image enhancement. However, when the models include generative models, such models can ‘fill in the blanks’ of the image with features that were not actually present in the source image, leading to ‘hallucinations’ or other unwanted artifacts.

### SUMMARY

An aspect of the present disclosure relates to a method that includes: (i) obtaining a first training dataset that comprises a plurality of high-quality images at a first resolution; (ii) generating, from the first training dataset, a second training dataset that comprises a plurality of degraded images at the first resolution by synthetically degrading the high-quality images of the first dataset; (iii) training a first image enhancement model to predict output images of the first training dataset when presented with corresponding input images from the second training dataset; (iv) applying images of the first training dataset to the trained first image enhancement model to generate a third training dataset that comprises a plurality of enhanced images at the first resolution; (v) generating, from the third training dataset, a fourth training dataset that comprises a plurality of degraded enhanced images at the first resolution by synthetically degrading the enhanced images of the third dataset; (vi) training a second image enhancement model to predict output images of the third training dataset when presented with corresponding input images from the fourth training dataset; and (vii) training a third image enhancement model to predict output images of the third training dataset at a second resolution when presented with corresponding input images from the fourth training dataset that have been downsampled to the second resolution, wherein the second resolution is a lower resolution than the first resolution.

Another aspect of the present disclosure relates to a method that includes applying a first image enhancement model to generate an output enhanced image at a first resolution from a target image at the first resolution. The first image enhancement model has been trained by: (i) obtaining a first training dataset that comprises a plurality of high-quality images at a second resolution, wherein the second resolution is a higher resolution than the first resolution; (ii) generating, from the first training dataset, a second training dataset that comprises a plurality of degraded images at the second resolution by synthetically degrading the high-quality images of the first dataset; (iii) training a second image enhancement model to predict output images of the first training dataset when presented with corresponding input images from the second training dataset; (iv) applying images of the first training dataset to the trained second image enhancement model to generate a third training dataset that comprises a plurality of enhanced images at the second resolution; (v) generating, from the third training dataset, a fourth training dataset that comprises a plurality of degraded enhanced images at the second resolution by synthetically degrading the enhanced images of the third dataset; (vi) training a third image enhancement model to predict output images of the third training dataset when presented with corresponding input images from the fourth training dataset; (vii) training a fourth image enhancement model to predict output images of the third training dataset at the first resolution when presented with corresponding input images from the fourth training dataset that have been downsampled to the first resolution; (viii) obtaining a fifth training dataset that comprises a plurality of images at the first resolution; (ix) generating, from the fifth training dataset, a sixth training dataset that comprises a plurality of enhanced images at the first resolution by, for a given image of the fifth training dataset: (a) generating an output enhanced image at the first resolution from the given image of the fifth training dataset by applying the given image to the fourth image enhancement model to generate a first intermediate image at the first resolution, (b) upsampling the first intermediate image to the second resolution, (c) applying the upsampled first intermediate image to the third image enhancement model to generate a second intermediate image at the second resolution, and (d) downsampling the second intermediate image to the first resolution to generate an enhanced image of the sixth training dataset that corresponds to the given image of the fifth training dataset; and (x) training the first image enhancement model to predict output images of the sixth training dataset when presented with corresponding input images from the fifth training dataset.

Another aspect of the present disclosure relates to a method that includes: (i) obtaining a first image enhancement model, the first image enhancement model having been trained using high-quality images; (ii) obtaining a first training dataset that comprises a plurality of low-quality images; (iii) generating, from the first training dataset, a second training dataset that comprises a plurality of enhanced versions of images of the first training dataset by, for a given image of the first training dataset, applying the given image of the first training dataset to the first image enhancement model to generate an enhanced image of the second training dataset that corresponds to the given image of the first training dataset; and (iv) training a second image enhancement model to predict output images of the second training dataset when presented with corresponding input images from the first training dataset.

Another aspect of the present disclosure relates to a method that includes applying a first image enhancement model to generate an output enhanced image from a target image. The first image enhancement model has been trained by: (i) obtaining a second image enhancement model, the second image enhancement model having been trained using high-quality images; (ii) obtaining a first training dataset that comprises a plurality of low-quality images; (iii) generating, from the first training dataset, a second training dataset that comprises a plurality of enhanced versions of images of the first training dataset by, for a given image of the first training dataset, applying the given image of the first training dataset to the second image enhancement model to generate an enhanced image of the second training dataset that corresponds to the given image of the first training dataset; and (iv) training the first image enhancement model to predict output images of the second training dataset when presented with corresponding input images from the first training dataset.

Another aspect of the present disclosure relates to an article of manufacture including a computer-readable medium, having stored thereon program instructions that, upon execution by a computing device, cause the computing device to perform operations to effect the method of any of the above aspects.

It will be appreciated that features described in the context of the first aspect can be implemented in the context of the second aspect. These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE FIGURES

FIG. 1A illustrates aspects of an example method.

FIG. 1B illustrates aspects of an example method.

FIG. 1C illustrates aspects of an example method.

Figure ID illustrates aspects of an example method.

FIG. 1E illustrates aspects of an example method.

FIG. 2A illustrates aspects of an example method.

FIG. 2B illustrates aspects of an example method.

FIG. 2C illustrates aspects of an example method.

FIG. 2D illustrates aspects of an example method.

FIG. 3 illustrates experimental results.

FIG. 4 is a simplified block diagram showing some of the components of an example system.

FIG. 5 is a flowchart of a method, according to an example embodiment.

FIG. 6 is a flowchart of a method, according to an example embodiment.

FIG. 7 is a flowchart of a method, according to an example embodiment.

FIG. 8 is a flowchart of a method, according to an example embodiment.

### DETAILED DESCRIPTION

Examples of methods and systems are described herein. It should be understood that the words “exemplary,” “example,” and “illustrative,” are used herein to mean “serving as an example, instance, or illustration.” Any embodiment or feature described herein as “exemplary,” “example,” or “illustrative,” is not necessarily to be construed as preferred or advantageous over other embodiments or features. Further, the exemplary embodiments described herein are not meant to be limiting. It will be readily understood that certain aspects of the disclosed systems and methods can be arranged and combined in a wide variety of different configurations.

It should be understood that the below embodiments, and other embodiments described herein, are provided for explanatory purposes, and are not intended to be limiting.

### I. Overview

It is desirable in many applications to enhance the quality of images, e.g., to correct for image artifacts, low resolution, image noise, poor lighting, over-compression, motion blur, or other unwanted factors or features of an image. However, it can be difficult to train an artificial neural network to perform such image enhancement. For example, a generative model could be trained, based on a large amount of ‘natural’ images to enhance novel input images. However, such models can ‘fill in the blanks’ of the image with content that was present in their training datasets but that was not actually present in the source image, leading to ‘hallucinations’ or other unwanted artifacts. Alternatively, pairs of images (one enhanced and one non-enhanced, that represent the same image content) could be used to train an image enhancement model. However, it is difficult to obtain sufficiently high-quality image pairs to train a model in that manner.

The model training and image enhancement methods and models described herein overcome these limitations by generating the models in an iterative, multi-stage manner. Each stage includes the training of a model and/or the generation of a training dataset that is then used to train a model and/or generate another training dataset in the subsequent stage.

The training methods described herein begin with a training dataset that includes a plurality of high-quality images and a corresponding set of degraded images generated therefrom, via a process of synthetic degradation. These high-quality images are then used to generate ‘enhanced’ high quality images that are of a sufficiently high quality that they can be used to train second-stage image enhancement models. Images of a quality similar to the ‘enhanced’ high quality images are in practice difficult to obtain, so this first stage (training a model to generate the ‘enhanced’ high quality images) provides for improved training of the second-stage models. The first stage includes training a first model to generate the original high-quality images from their degraded versions. The first model, which has now been trained to enhance input images, is then applied to a set of high-quality images (e.g., the same images used to train the first model) to generate “enhanced” high quality images. The set of ‘enhanced’ high quality images are then synthetically degraded to generate the training dataset used to train the second-stage models.

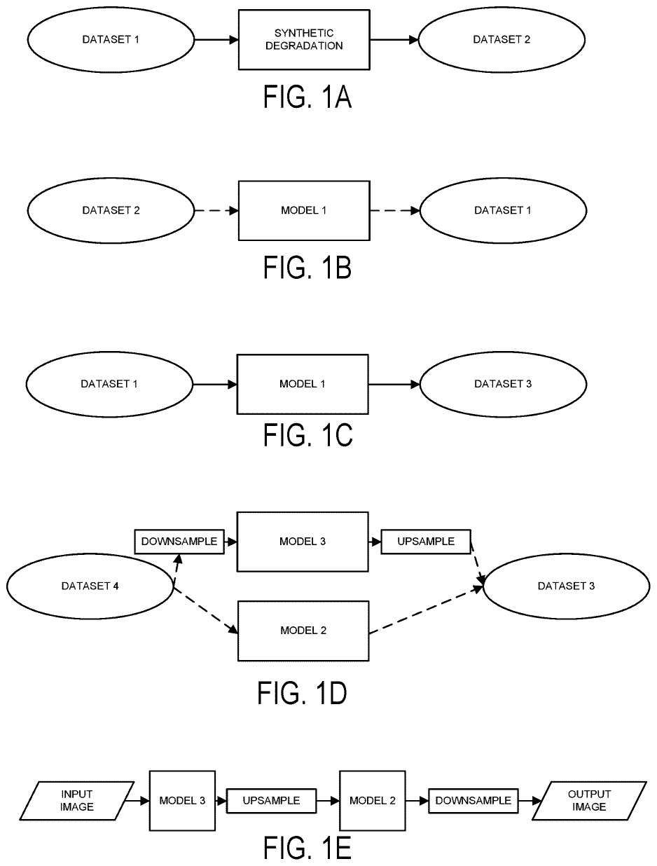

FIGS. 1A-C depict aspects of such a first-stage process for ‘bootstrapping’ ultra-high-quality images from high quality images, for use in training the second-stage models. FIG. 1A depicts the generation, from a first dataset (“DATASET 1”) that comprises high-quality images, of a second dataset (“DATASET 2”) by synthetically degrading the images of the first dataset (“SYNTHETIC DEGRADATION”). FIG. 1B depicts the use of pairs of images (i.e., of images from the first dataset and the images of the second dataset generated by synthetically degrading the images from the first dataset) to train a first image enhancement model (“MODEL 1”) to predict the original high-quality images from synthetically degraded versions thereof. The set of high quality images of the first dataset could include images professionally generated, using professional-quality cameras, under high-quality lighting, etc. and/or that have been selected for having a high quality (e.g., via manual selection, via use of an automated method for determining image quality) from a set of low and high quality images.

Once the first image enhancement model has been trained, it is used to generate, from the first dataset (e.g., from the same images used to train to generate the first model and/or images of the first dataset that were not used in training the first model), a third dataset of enhanced images (“DATASET 3”). Images of this third dataset are of especially high quality, and so can be used to train further image enhancement models to have higher quality than if the non-enhanced high-quailty images of the first dataset

Once this first image enhancement model has been trained and used to generate a dataset of enhanced high-quality images, the set of high-quality images can then be used to train second-stage image enhancement models. This includes generating, from the third dataset of enhanced high-quality images, a fourth dataset (“DATASET 4”) by synthetically degrading the images of the third dataset. The paired third and fourth datasets are then used to train two different image enhancement models (“MODEL 2” and “MODEL 3”), at respective different image resolutions, to predict the images of the third dataset from their corresponding degraded versions of the fourth dataset. The models are trained at two different resolutions (one higher, at the ‘native’ resolution of the third and fourth datasets, and one at a lower resolution) so that they can be used serially at inference time to enhance novel images at respective different resolutions and image feature scales.

FIG. 1D depicts the use of pairs of images (i.e., of images from the third dataset and the images of the fourth dataset generated by synthetically degrading the images from the fourth dataset) to train the second image enhancement model (“MODEL 2”) and the third image enhancement model (“MODEL 3”) at respective different resolutions (e.g., edges, textures). This includes, for the third model, applying a downsampled version of an image of the fourth dataset as an input to the third model and then upsampling the output therefrom to compare to the corresponding image of the third dataset (e.g., to generate a loss function that can be used to update or otherwise train the parameters of the third model).

Synthetic degradation of images (e.g., of the images of the first dataset to generate the second dataset, or of the images of the third dataset to generate the fourth dataset) could include a variety of processes to synthetically introduce noise, blur, motion, or other artifacts to degrade the input images. For example, synthetic degradation of images could include at least one of adding Gaussian noise, adding camera noise, adding Gaussian blur, adding motion blur, down-sampling, and/or adding encoding artifacts.

Finally, the trained second and third models can be applied, serially, to enhance images at the lower resolution of the third model. FIG. 1E depicts such an inference process, wherein an input image (“INPUT IMAGE”) at the second, lower resolution is applied to the third image enhancement model to generate an output at the second resolution. This output is upsampled (“UPSAMPLE”) to the first, higher resolution and then applied to the second image enhancement model to generate an output at the first resolution. This output is then downsampled (“DOWNSAMPLE”) to the second resolution to generate an output image (“OUTPUT IMAGE”) that is an enhanced version of the input image.

The higher and lower resolutions of the first and second image enhancement models and the third image enhancement model, respectively, could be a variety of different resolutions, according to an application. The lower resolution could be selected to comport with the desired resolution of images to be enhanced using the trained models. For example, the lower image resolution could be 512×512 and the higher image resolution could be 1024×1024.

Further, since the resolution of the first image enhancement model and the second image enhancement model are the same, the third image enhancement model could optionally be trained by starting with the first image enhancement model and continuing the training thereof using the third and fourth training datasets.

The execution of multiple models, which may require significant computational resources (e.g., memory, compute cycles, number of cores), may make execution of the serial image enhancement scheme described herein (e.g., in connection with FIG. 1E) difficult in certain contexts (e.g., smartphones or other limited-resource contexts) and/or within certain constraints (e.g., a latency constraint in order to perform image enhancement in near-real-time for frames of a video call or other video stream). In some examples, this limitation could be addressed by selecting a portion of particular interest within an image (e.g., a face), extracting that portion of the image, and then performing image enhancement only on the extracted portion. For example, image enhancement could be performed only on face(s) detected within images (e.g., within frames of a video call). This can allow the resolution of the trained models to be reduced (e.g., to comport with the expected size of a face or other feature of interest within the frame of a larger image), thereby reducing the computational cost to enhance the face or other portion of interest within the larger image.

Additionally or alternatively, the computational cost of enhancing an image could be reduced by using the trained second-stage models (the second and third image enhancement models), or some other teacher model(s), to train a simpler model to perform image enhancement. This has the benefit that the more complex models, having more degrees of freedom, can more easily explore the space of the ‘image enhancement’ problem, and thus result in higher accuracy based on fewer, higher-quality training examples. These more complex models can then be used to generate relatively larger training datasets, using relatively lower-quality training data, that can be used to achieve greater accuracy in relatively less complex models that exhibit decreased computational cost to execute (e.g., less memory, fewer compute cycles, fewer cores). Such lower-quality images could be generated using poorer cameras (e.g., front-facing cameras of smart phones), under poorer light conditions, with lower resolution, exhibiting more motion, blur, compression, or other artifacts, or otherwise have a lower quality that the images used to train the teacher model(s) (e.g., using the training methods described above.

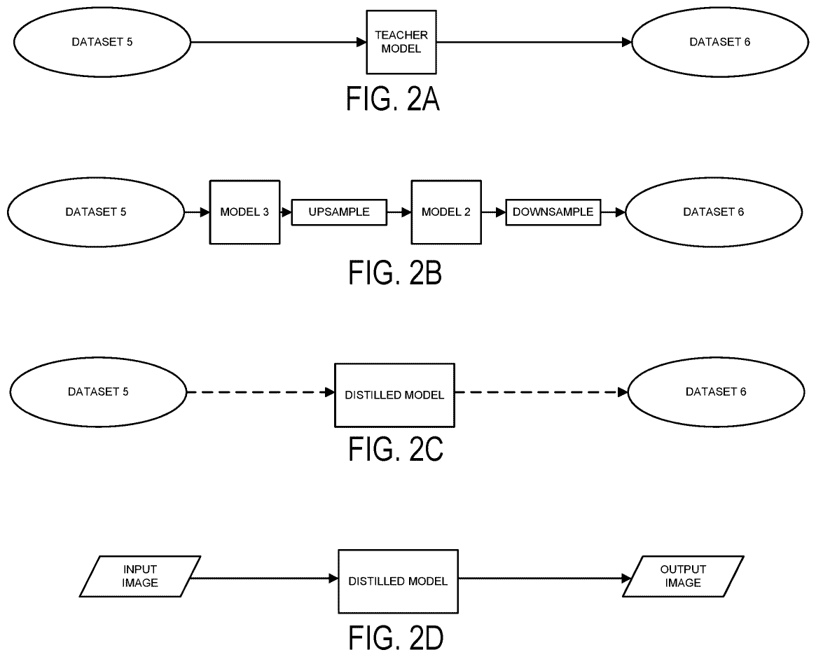

FIG. 2A illustrates an examples of a teacher model (“TEACHER MODEL”), which has been trained on high-quality images, generating, from a fifth dataset (“DATASET 5”) that includes low-quality images, a sixth dataset (“DATASET 6”) that contains enhanced versions of the images of the fifth dataset. The teacher model could include a set of models as described above. For example, as shown in FIG. 2B, images of the sixth dataset could be generated by applying images of the fifth dataset to the third image enhancement model, upsampling the low-resolution enhanced images output from the third model, applying the upsampled images to the second image enhancement model to generate high-resolution enhanced output images, and then downsampling those high-resolution enhanced images.

Finally, as depicted in FIG. 2C, the fifth and sixth datasets are used to train a distilled model (“DISTILLED MODEL”) to generate the enhanced images of the sixth dataset from the low-quality, non-enhanced images of the fifth dataset. This distilled model can then be used, as shown in FIG. 2D, to receive input images (“INPUT IMAGE”) as input and to output enhanced versions thereof as output (“OUTPUT IMAGE”). Such a distilled model could include the MobileNet architecture or some other relatively lightweight image processing model architecture that has been adapted to use on computationally limited systems, e.g., smart phones.

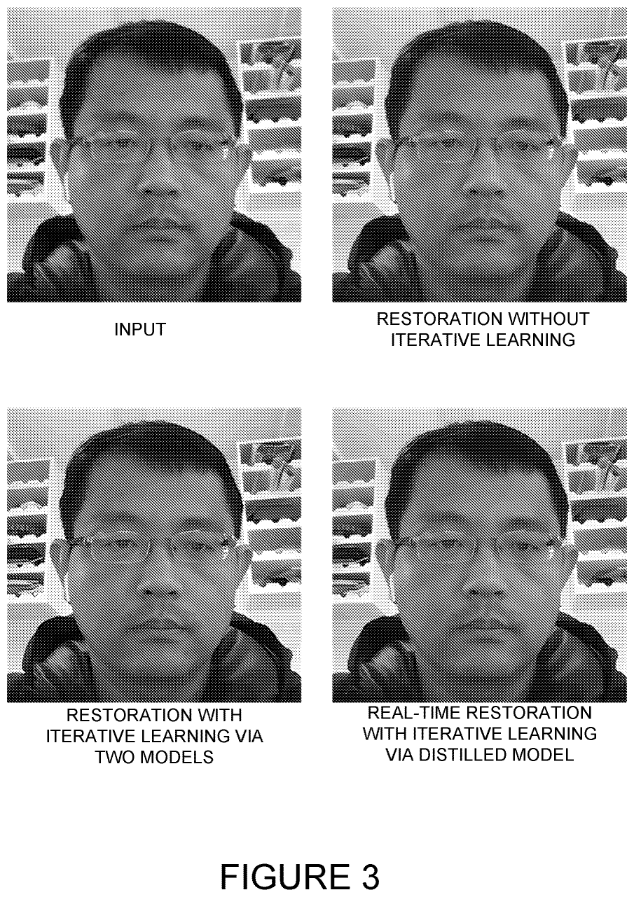

FIG. 3 illustrates an example of a low-quality input image (top left, e.g., from the fifth dataset of FIGS. 2A-C) and an enhanced version thereof generated via methods other than those described herein (top right, e.g., by only training a single image enhancement model once based on a single set of input training images and degraded versions thereof). FIG. 3 also shows an enhanced image generated via the application in series of the higher and lower resolution image enhancement models to the input image (bottom left, e.g., using the second and third image enhancement models). FIG. 3 also depicts (bottom right) an image generated by a lightweight distilled model trained, as described above, using training datasets generated using the trained higher and lower resolution image enhancement models applied in series to low-quality training images.

The computational cost of executing the distilled model to generate 512×512 images was assessed on a variety of different hardware. The model took 20.0 ms to execute using the GPU of the Pixel 6 smart phone, 17.9 ms to execute using the NPU of the Pixel 6 smart phone, 5.1 ms to execute using the NPU of the Pixel 7 smart phone, and 5.5 ms to execute within the WebGL environment on a MacBook Pro MI.

As noted above, such a distillation process can result in a distilled image enhancement model that exhibits similar benefits with respect to image enhancement as the teacher model(s) (e.g., as the series application of the second and third image enhancement models) while requiring reduced computational costs or resources to execute. This could enable image enhancement to be performed on resource-limited systems, e.g., by smart phones, and/or at lower latency (e.g., at real-time or near-real-time, enabling the enhancement of frames of a video stream as they are generated and/or received). So, in some applications, a server, cloud computing system, or other large computational system could operate to generate a relatively lightweight distilled model (e.g., using the iterative, multi-stage training methods described herein) using one or more sets of training images (e.g., a set of high-quality images and a set of low-quality images). Such a large computational system could then transmit the lightweight distilled model to one or more remote systems (e.g., smart phones), e.g., via a wired or wireless connection. Additionally or alternatively, the lightweight distilled model could be added to the remote system via some other method, e.g., using physical storage media, by programming the model into the remote system when the remote system is fabricated/initially programmed, etc.

### II. Example Systems

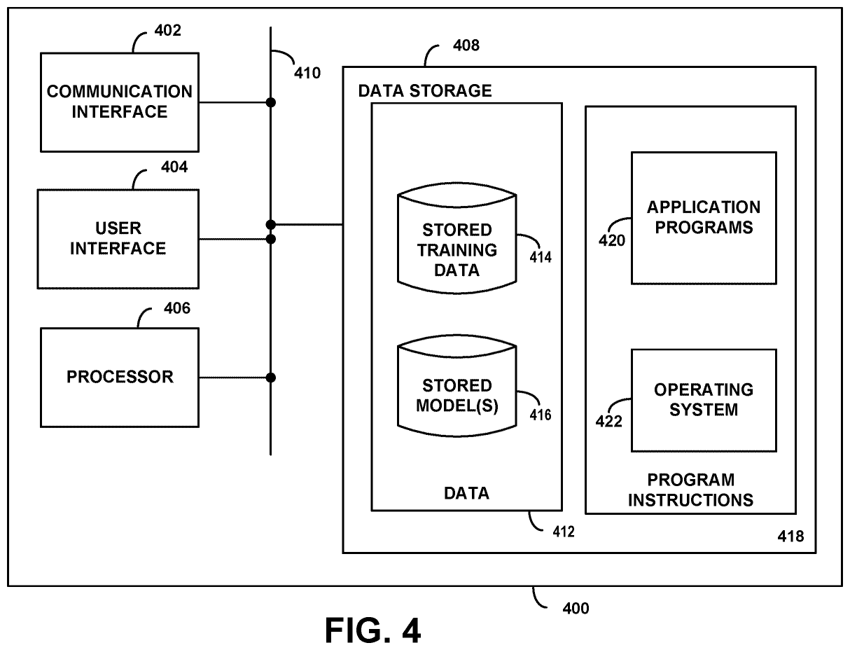

FIG. 4 illustrates an example system 400 that may be used to implement the methods described herein. By way of example and without limitation, system 400 may be or include a computer (such as a desktop, notebook, tablet, or handheld computer, a server), elements of a cloud computing system, a smartphone, or some other type of device or system. It should be understood that elements of system 400 may represent a physical instrument and/or computing device such as a server, a particular physical hardware platform on which applications operate in software, or other combinations of hardware and software that are configured to carry out functions as described herein.

As shown in FIG. 4, system 400 may include a communication interface 402, a user interface 404, one or more processor(s) 406, and data storage 408, all of which may be communicatively linked together by a system bus, network, or other connection mechanism 410.

Communication interface 402 may function to allow system 400 to communicate, using analog or digital modulation of electric, magnetic, electromagnetic, optical, or other signals, with other devices, access networks, and/or transport networks. Thus, communication interface 402 may facilitate circuit-switched and/or packet-switched communication, such as plain old telephone service (POTS) communication and/or Internet protocol (IP) or other packetized communication. For instance, communication interface 402 may include a chipset and antenna arranged for wireless communication with a radio access network or an access point. Also, communication interface 402 may take the form of or include a wireline interface, such as an Ethernet, Universal Serial Bus (USB), or High-Definition Multimedia Interface (HDMI) port. Communication interface 402 may also take the form of or include a wireless interface, such as a Wifi, BLUETOOTH®, global positioning system (GPS), or wide-area wireless interface (e.g., 3GPP Long-Term Evolution (LTE), or 3GPP 5G). However, other forms of physical layer interfaces and other types of standard or proprietary communication protocols may be used over communication interface 402. Furthermore, communication interface 402 may comprise multiple physical communication interfaces (e.g., a Wifi interface, a BLUETOOTH® interface, and a wide-area wireless interface).

In some embodiments, communication interface 402 may function to allow system 400 to communicate, with other devices, remote servers, access networks, and/or transport networks. For example, the communication interface 402 may function to communicate with one or more requestor devices (e.g., smartphone) to receive images, to apply the methods described herein to enhance the improved images, and to transmit the enhanced images back to the requestor device(s). Additionally or alternatively, the communication interface 402 may function to communicate with one or more remote devices (e.g., smartphones) to transmit indications of models generated by the system 400 using the methods described herein.

User interface 404 may function to allow system 400 to interact with a user, for example to receive input from and/or to provide output to the user. Thus, user interface 404 may include input components such as a keypad, keyboard, touch-sensitive or presence-sensitive panel, computer mouse, trackball, joystick, microphone, and so on. User interface 404 may also include one or more output components such as a display screen which, for example, may be combined with a presence-sensitive panel. The display screen may be based on CRT, LCD, and/or LED technologies, or other technologies now known or later developed. User interface 404 may also be configured to generate audible output(s), via a speaker, speaker jack, audio output port, audio output device, earphones, and/or other similar devices.

Processor(s) 406 may comprise one or more general purpose processors—e.g., microprocessors—and/or one or more special purpose processors—e.g., digital signal processors (DSPs), graphics processing units (GPUs), floating point units (FPUs), network processors, tensor processing units (TPUs), or application-specific integrated circuits (ASICs). In some instances, special purpose processors may be capable of model execution (e.g., execution of artificial neural networks or other machine learning models), training of models, generation of training datasets for the training of models, or other functions as described herein, among other applications or functions. Data storage 408 may include one or more volatile and/or non-volatile storage components, such as magnetic, optical, flash, or organic storage, and may be integrated in whole or in part with processor(s) 406. Data storage 408 may include removable and/or non-removable components.

Processor(s) 406 may be capable of executing program instructions 418 (e.g., compiled or non-compiled program logic and/or machine code) stored in data storage 408 to carry out the various functions described herein. Therefore, data storage 408 may include a non-transitory computer-readable medium, having stored thereon program instructions that, upon execution by system 400, cause system 400 to carry out any of the methods, processes, or functions disclosed in this specification and/or the accompanying drawings. The execution of program instructions 418 by processor(s) 406 may result in processor 406 using data 412.

By way of example, program instructions 418 may include an operating system 422 (e.g., an operating system kernel, device driver(s), and/or other modules) and one or more application programs 420 (e.g., functions for executing the methods described herein) installed on system 400. Data 412 may include stored training data 414 (e.g., high-quality images, low-quality images, enhanced images, sets of pairs of images). Data 412 may also include stored models 416 (e.g., stored model parameters and other model-defining information) that can be executed as part of the methods described herein (e.g., to determine, from an input image, an enhanced version of the input image).

Application programs 420 may communicate with operating system 422 through one or more application programming interfaces (APIs). These APIs may facilitate, for instance, application programs 420 transmitting or receiving information via communication interface 402, receiving and/or displaying information on user interface 404, and so on.

Application programs 420 may take the form of “apps” that could be downloadable to system 400 through one or more online application stores or application markets (via, e.g., the communication interface 402). However, application programs can also be installed on system 400 in other ways, such as via a web browser or through a physical interface (e.g., a USB port) of the system 400.

### III. Example Methods

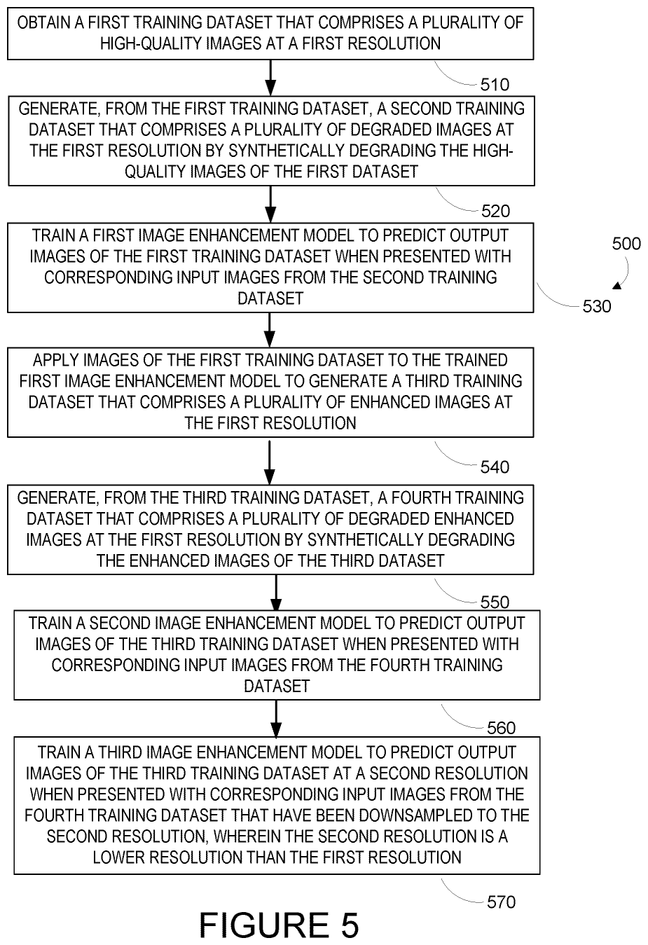

FIG. 5 is a flowchart of a method 500 for generating image enhancement models as described herein. The method 500 includes obtaining a first training dataset that comprises a plurality of high-quality images at a first resolution (510). The method 500 additionally includes generating, from the first training dataset, a second training dataset that comprises a plurality of degraded images at the first resolution by synthetically degrading the high-quality images of the first dataset (520). The method 500 yet further includes training a first image enhancement model to predict output images of the first training dataset when presented with corresponding input images from the second training dataset (530). The method 500 additionally includes applying images of the first training dataset to the trained first image enhancement model to generate a third training dataset that comprises a plurality of enhanced images at the first resolution (540). The method 500 further includes generating, from the third training dataset, a fourth training dataset that comprises a plurality of degraded enhanced images at the first resolution by synthetically degrading the enhanced images of the third dataset (550). The method 500 additionally includes training a second image enhancement model to predict output images of the third training dataset when presented with corresponding input images from the fourth training dataset (560). The method 500 also includes training a third image enhancement model to predict output images of the third training dataset at a second resolution when presented with corresponding input images from the fourth training dataset that have been downsampled to the second resolution, wherein the second resolution is a lower resolution than the first resolution (570).

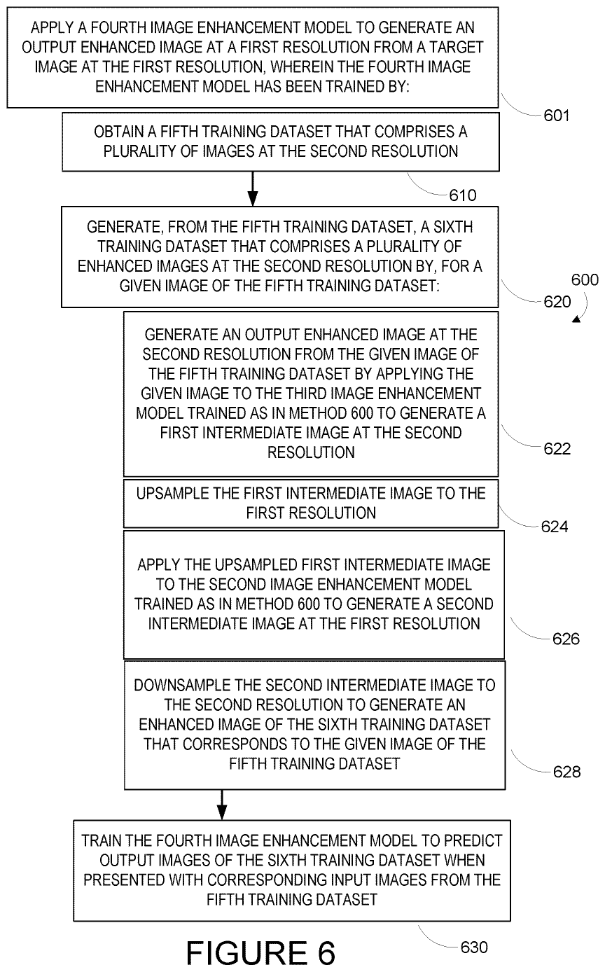

FIG. 6 is a flowchart of a method 600 for enhancing an image using an image enhancement model as describe herein. The method 600 includes applying a fourth image enhancement model to generate an output enhanced image at the second resolution from a target image at the second resolution (601). The fourth image enhancement model has been trained by:
obtaining a fifth training dataset that comprises a plurality of images at the second resolution (610);
generating, from the fifth training dataset, a sixth training dataset that comprises a plurality of enhanced images at the first resolution (620). this includes, for a given image of the fifth training dataset: generating an output enhanced image at the second resolution from the given image of the fifth training dataset by applying the given image to the third image enhancement model trained as in method 600 to generate a first intermediate image at the second resolution (622); upsampling the first intermediate image to the first resolution (624); applying the upsampled first intermediate image to the second image enhancement model trained as in method 600 to generate a second intermediate image at the first resolution (626); and downsampling the second intermediate image to the second resolution to generate an enhanced image of the sixth training dataset that corresponds to the given image of the fifth training dataset (628); and
training the fourth image enhancement model to predict output images of the sixth training dataset when presented with corresponding input images from the fifth training dataset (630).

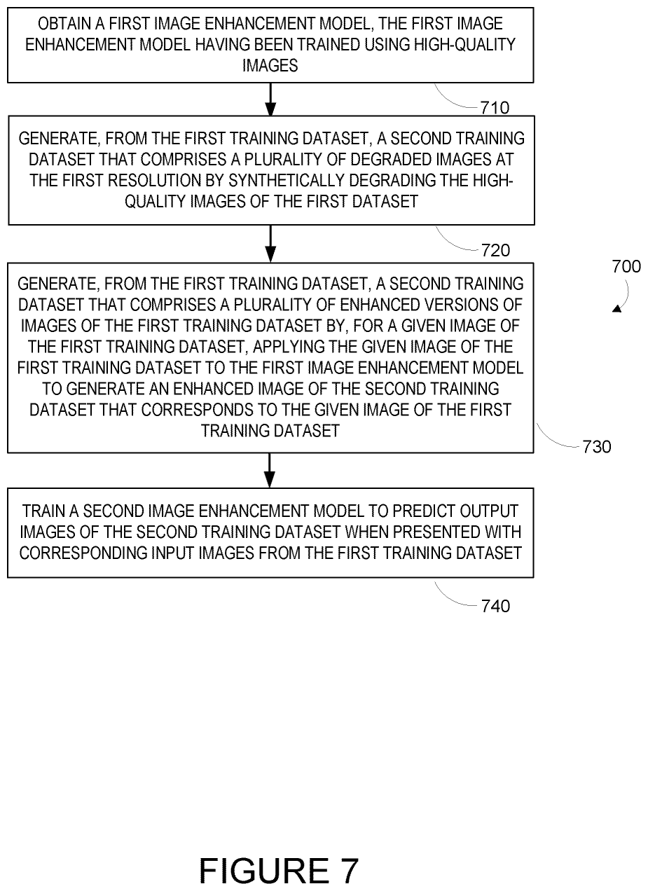

FIG. 7 is a flowchart of a method 600 for generating image enhancement models as described herein. The method 700 includes obtaining a first image enhancement model, the first image enhancement model having been trained using high-quality images (710). The method 700 additionally includes obtaining a first training dataset that comprises a plurality of low-quality images (720). the method 700 yet further includes generating, from the first training dataset, a second training dataset that comprises a plurality of enhanced versions of images of the first training dataset by, for a given image of the first training dataset, applying the given image of the first training dataset to the first image enhancement model to generate an enhanced image of the second training dataset that corresponds to the given image of the first training dataset (730). The method 700 also includes training a second image enhancement model to predict output images of the second training dataset when presented with corresponding input images from the first training dataset (740).

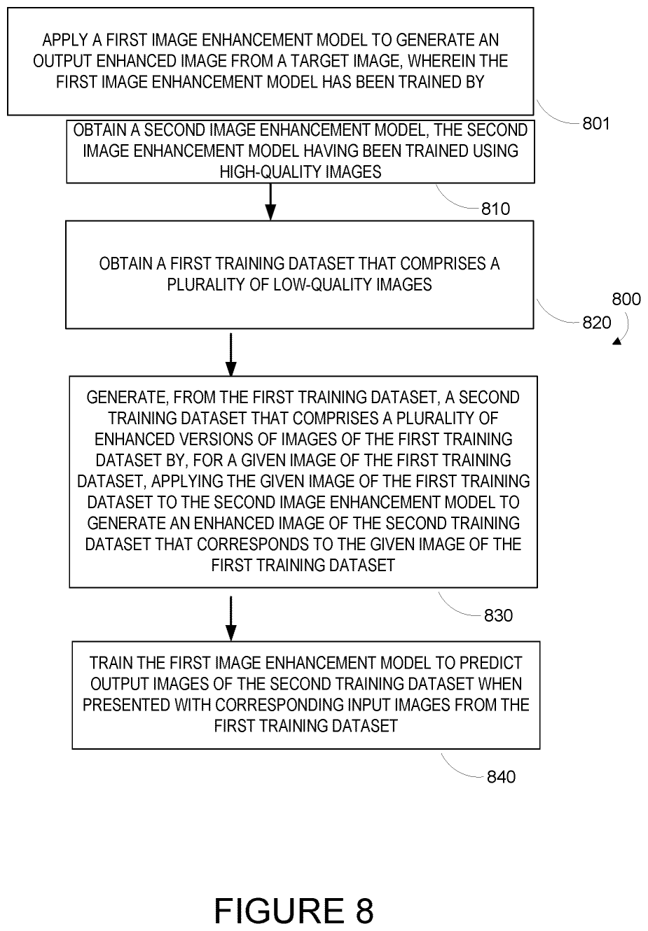

FIG. 8 is a flowchart of a method 800 for enhancing an image using an image enhancement model as described herein. The method 800 includes applying a first image enhancement model to generate an output enhanced image from a target image (801). the first image enhancement model has been trained by:
obtaining a second image enhancement model, the second image enhancement model having been trained using high-quality images (810);
obtaining a first training dataset that comprises a plurality of low-quality images (820);
generating, from the first training dataset, a second training dataset that comprises a plurality of enhanced versions of images of the first training dataset by, for a given image of the first training dataset, applying the given image of the first training dataset to the second image enhancement model to generate an enhanced image of the second training dataset that corresponds to the given image of the first training dataset (830); and
training the first image enhancement model to predict output images of the second training dataset when presented with corresponding input images from the first training dataset (840).

Any or all of the methods 500, 600, 700, 800 could include additional elements or features.

### IV. Conclusion

The above detailed description describes various features and functions of the disclosed systems, devices, and methods with reference to the accompanying figures. In the figures, similar symbols typically identify similar components, unless context indicates otherwise. The illustrative embodiments described in the detailed description, figures, and claims are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flowcharts in the figures and as discussed herein, each step, block and/or communication may represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages may be executed out of order from that shown or discussed, including in substantially concurrent or in reverse order, depending on the functionality involved. Further, more or fewer steps, blocks and/or functions may be used with any of the message flow diagrams, scenarios, and flow charts discussed herein, and these message flow diagrams, scenarios, and flow charts may be combined with one another, in part or in whole.

A step or block that represents a processing of information may correspond to circuitry that can be configured to perform the specific logical functions of a herein-described method or technique. Alternatively or additionally, a step or block that represents a processing of information may correspond to a module, a segment, or a portion of program code (including related data), The program code may include one or more instructions executable by a processor for implementing specific logical functions or actions in the method or technique. The program code and/or related data may be stored on any type of computer-readable medium, such as a storage device, including a disk drive, a hard drive, or other storage media.

The computer-readable medium may also include non-transitory computer-readable media such as computer-readable media that stores data for short periods of time like register memory, processor cache, and/or random access memory (RAM). The computer-readable media may also include non-transitory computer-readable media that stores program code and/or data for longer periods of time, such as secondary or persistent long term storage, like read only memory (ROM), optical or magnetic disks, and/or compact-disc read only memory (CD-ROM), for example. The computer-readable media may also be any other volatile or non-volatile storage systems. A computer-readable medium may be considered a computer-readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

1. A method comprising:
obtaining a first training dataset that comprises a plurality of high-quality images at a first resolution;
generating, from the first training dataset, a second training dataset that comprises a plurality of degraded images at the first resolution by synthetically degrading the high-quality images of the first dataset;
training a first image enhancement model to predict output images of the first training dataset when presented with corresponding input images from the second training dataset;
applying images of the first training dataset to the trained first image enhancement model to generate a third training dataset that comprises a plurality of enhanced images at the first resolution;
generating, from the third training dataset, a fourth training dataset that comprises a plurality of degraded enhanced images at the first resolution by synthetically degrading the enhanced images of the third dataset;
training a second image enhancement model to predict output images of the third training dataset when presented with corresponding input images from the fourth training dataset; and
training a third image enhancement model to predict output images of the third training dataset at a second resolution when presented with corresponding input images from the fourth training dataset that have been downsampled to the second resolution, wherein the second resolution is a lower resolution than the first resolution.

2. The method of claim 1, further comprising:
generating an output enhanced image at the second resolution from a target image at the second resolution by applying the target image to the third image enhancement model to generate a first intermediate image at the second resolution, upsampling the first intermediate image to the first resolution, applying the upsampled first intermediate image to the second image enhancement model to generate a second intermediate image at the first resolution, and downsampling the second intermediate image to the second resolution.

3. The method of claim 1, further comprising:
obtaining a fifth training dataset that comprises a plurality of images at the second resolution;
generating, from the fifth training dataset, a sixth training dataset that comprises a plurality of enhanced images at the second resolution by, for a given image of the fifth training dataset:
generating an output enhanced image at the second resolution from the given image of the fifth training dataset by applying the given image to the third image enhancement model to generate a first intermediate image at the second resolution, upsampling the first intermediate image to the first resolution,
applying the upsampled first intermediate image to the second image enhancement model to generate a second intermediate image at the first resolution, and
downsampling the second intermediate image to the second resolution to generate an enhanced image of the sixth training dataset that corresponds to the given image of the fifth training dataset; and
training a fourth image enhancement model to predict output images of the sixth training dataset when presented with corresponding input images from the fifth training dataset.

4. The method of claim 3, wherein a model architecture of the fourth image enhancement model is the MobileNet architecture.

5. The method of claim 3, wherein the fifth training dataset comprises a plurality of low-quality images at the second resolution.

6. The method of claim 3, further comprising:
generating an output enhanced image at the second resolution from a target image at the second resolution by applying the target image to the fourth image enhancement model.

7. The method of claim 6, further comprising:
transmitting the fourth image enhancement model from a server to a remote system, wherein generating the output enhanced image from the target image is performed by at least one processor of the remote system, wherein the remote system is a smartphone, and wherein generating the output enhanced image from the target image takes less than 20 milliseconds to perform.

8. (canceled)

9. The method of claim 6, further comprising:
obtaining a source image;
determining a location of a face within the source image; and
extracting a portion of the source image corresponding to the determined location of the face within the source image, wherein the target image is the extracted portion of the source image.

10. The method of claim 9, wherein obtaining the source image comprises obtaining a video stream, wherein the source image is a frame of the video stream.

11. The method of claim 10, wherein obtaining the video stream, obtaining the source image, determining the location of the face within the source image, extracting the portion of the source image, and generating the output enhanced image from the target image by applying the target image to the fourth image enhancement model are performed by at least one processor of a smartphone.

12. (canceled)

13. The method of claim 1, wherein synthetically degrading the high-quality images of the first dataset comprises at least one of adding Gaussian noise, adding camera noise, adding Gaussian blur, adding motion blur, down-sampling, and adding encoding artifacts.

14. A method comprising:
applying a first image enhancement model to generate an output enhanced image at a first resolution from a target image at the first resolution, wherein the first image enhancement model has been trained by:
obtaining a first training dataset that comprises a plurality of high-quality images at a second resolution, wherein the second resolution is a higher resolution than the first resolution;
generating, from the first training dataset, a second training dataset that comprises a plurality of degraded images at the second resolution by synthetically degrading the high-quality images of the first dataset;
training a second image enhancement model to predict output images of the first training dataset when presented with corresponding input images from the second training dataset;
applying images of the first training dataset to the trained second image enhancement model to generate a third training dataset that comprises a plurality of enhanced images at the second resolution;
generating, from the third training dataset, a fourth training dataset that comprises a plurality of degraded enhanced images at the second resolution by synthetically degrading the enhanced images of the third dataset;
training a third image enhancement model to predict output images of the third training dataset when presented with corresponding input images from the fourth training dataset;
training a fourth image enhancement model to predict output images of the third training dataset at the first resolution when presented with corresponding input images from the fourth training dataset that have been downsampled to the first resolution;
obtaining a fifth training dataset that comprises a plurality of images at the first resolution;
generating, from the fifth training dataset, a sixth training dataset that comprises a plurality of enhanced images at the first resolution by, for a given image of the fifth training dataset:
generating an output enhanced image at the first resolution from the given image of the fifth training dataset by applying the given image to the fourth image enhancement model to generate a first intermediate image at the first resolution,
upsampling the first intermediate image to the second resolution,
applying the upsampled first intermediate image to the third image enhancement model to generate a second intermediate image at the second resolution, and
downsampling the second intermediate image to the first resolution to generate an enhanced image of the sixth training dataset that corresponds to the given image of the fifth training dataset; and
training the first image enhancement model to predict output images of the sixth training dataset when presented with corresponding input images from the fifth training dataset.

15. The method of claim 14, wherein a model architecture of the first image enhancement model is the MobileNet architecture.

16. The method of claim 14, wherein the fifth training dataset comprises a plurality of low-quality images at the first resolution.

17. The method of claim 14, further comprising:
receiving, by a remote system, the first image enhancement model from a server, wherein generating the output enhanced image from the target image is performed by at least one processor of the remote system, wherein the remote system is a smartphone, and wherein generating the output enhanced image from the target image takes less than 20 milliseconds to perform.

18. (canceled)

19. The method of claim 17, further comprising:
obtaining a source image;
determining a location of a face within the source image; and
extracting a portion of the source image corresponding to the determined location of the face within the source image, wherein the target image is the extracted portion of the source image.

20. The method of claim 19, wherein obtaining the source image comprises obtaining a video stream, wherein the source image is a frame of the video stream.

21. The method of claim 20, wherein obtaining the video stream, obtaining the source image, determining the location of the face within the source image, extracting the portion of the source image, and generating the output enhanced image from the target image by applying the target image to the first image enhancement model are performed by at least one processor of a smartphone.

22. (canceled)

23. The method of claim 14, wherein synthetically degrading the high-quality images of the first dataset comprises at least one of adding Gaussian noise, adding camera noise, adding Gaussian blur, adding motion blur, down-sampling, and adding encoding artifacts.

24.-39. (cancelled)

40. A system comprising:
a controller comprising one or more processors; and
a computer-readable medium having stored thereon program instructions that, upon execution by the one or more processors, cause the controller to perform operations comprising:
obtaining a first training dataset that comprises a plurality of high-quality images at a first resolution;
generating, from the first training dataset, a second training dataset that comprises a plurality of degraded images at the first resolution by synthetically degrading the high-quality images of the first dataset;
training a first image enhancement model to predict output images of the first training dataset when presented with corresponding input images from the second training dataset;
applying images of the first training dataset to the trained first image enhancement model to generate a third training dataset that comprises a plurality of enhanced images at the first resolution;
generating, from the third training dataset, a fourth training dataset that comprises a plurality of degraded enhanced images at the first resolution by synthetically degrading the enhanced images of the third dataset;
training a second image enhancement model to predict output images of the third training dataset when presented with corresponding input images from the fourth training dataset; and
training a third image enhancement model to predict output images of the third training dataset at a second resolution when presented with corresponding input images from the fourth training dataset that have been downsampled to the second resolution, wherein the second resolution is a lower resolution than the first resolution.
